(19) United States
(12) Patent Application Publication
(10) Pub. No.: US 2023/0183535 A1
(43) Pub. Date: Jun. 15, 2023

(54) ICE AND SNOW MELT COMPOSITION AND METHOD OF MAKING

(71) Applicant: Solarmelts Inc., Jersey City, NJ (US)

(72) Inventor: JARED DAY, JERSEY CITY, NJ (US)

(21) Appl. No.: 18/064,885

(22) Filed: Dec. 12, 2022

Related U.S. Application Data
(60) Provisional application No. 63/288,843, filed on Dec. 13, 2021.

(51) Int. Cl. C09K 3/18; C08L 79/02; C08L 3/02; C08L 5/00; C08L 5/12; C08K 3/36; C08K 3/04; C09D 5/00; C09D 7/61; C09D 7/20; C09D 103/02; C09D 179/02; C09D 105/02; C09D 105/12

(52) U.S. Cl. CPC C09K 3/185; C08L 79/02; C08L 3/02; C08L 5/00; C08L 5/12; C08K 3/36; C08K 3/04; C09D 5/00; C09D 7/61; C09D 7/20; C09D 103/02; C09D 179/02; C09D 105/02; C09D 105/12; C08L 2201/06

(57) ABSTRACT

A composition used to melt ice and snow is provided. The composition has a large solar radiation absorption bandwidth and good thermal conduction, which can be manually, mechanically or otherwise dispersed over a large or small surface area to aid in melting ice or snow into liquid when exposed to optical radiation. A method for preparing the composition and methods of use of the composition are also provided.

### CROSS REFERENCE TO RELATED APPLICATIONS

This patent application claims the benefit of U.S. Provisional Application No. 63/288,843 filed Dec. 13, 2021, which is incorporated herein by reference.

### BACKGROUND

### Field of the Invention

This disclosure relates generally to compositions for melting ice and snow and more particularly to a biodegradable solar-activated (by visible radiation and infrared radiation) ice and snow melting composition, wherein the biodegradable composition includes a water-soluble binding agent, such as sugar or carbohydrate polymers (natural polymers), along with a carbon source, such as graphite. This ice-melting composition exhibits a temperature increase through the absorption of solar radiation and uses its increased temperature to heat and melt the surrounding ice and snow without the use of any chemical reactions. Methods of use thereof and a method of preparing the compositions are also disclosed.

### Related Art

Currently, ice and snow melting compositions known as de-icers are used in agriculture, on roadways, and vehicles to aid in melting ice or snow during the winter. De-icers may be liquid, granular or chemically reactive and the application thereof depends on the surface to which it is applied to. Some surfaces are prone to corrosion if a chemically reactive de-icer is used. Municipal water supplies can become contaminated from chemicals used in current de-icer products.

Some common de-icer ingredients include sodium chloride, magnesium chloride, calcium chloride, calcium-magnesium acetate, potassium acetate or glycol, urea, potassium formate, sodium formate solid, potassium acetate liquid, rubbing alcohol, white vinegar and brine or beet juice. However, it has been found that there are disadvantages to these ingredients that may cause damage to surfaces, vehicles, and may also be toxic to the environment.

Current de-icer compositions melt ice or snow using a chemical reaction to affect the melting temperature of the ice and/or snow. Current compositions operate quickly but are usually effective up to approximately one hour or at most one full one day. Further, these compositions are also expensive as there needs to be constant re-application of the composition to aid in melting ice on roadways, plants and property. It has also been found that current compositions used to aid in melting ice have a short shelf life.

There exists a need for a composition to aid in melting ice or snow that is non-toxic, non-corrosive, cost-efficient and is effective for a longer period.

### SUMMARY OF THE INVENTION

It is to be understood that the phraseology and terminology employed herein are for the purpose of the description and should not be regarded as limiting. This application relates to an ice and snow melting composition that is activated when exposed to solar or thermal radiation and is biodegradable. The composition operates by heat transfer of thermal energy from solar radiation or other thermal radiation source to melt surrounding ice, snow, or frost. The composition does not use chemical reactions to melt ice, resulting in no chemical byproducts that are harmful to the environment or corrosive to vehicles or equipment. Since the composition is biodegradable and produces no harmful chemical byproducts, it is a safe alternative to current ice-melting tools used on roadways, on agricultural equipment, in agricultural fields and on crops. When the composition absorbs solar energy, melting of ice, snow, or frost may occur over several hours and days. After applying the composition to a surface, at least about 30% to about 90% loss of mass of 0.200kg of ice or snow is achieved after 12 hours of direct sunlight.

In one embodiment, the composition comprises a binder, wherein the binder includes a binding agent, and a carbon source, wherein the composition absorbs solar radiation in the form of visible or infrared light. In some embodiments, the composition further includes a solvent.

In some embodiments, the composition includes a substrate wherein the substrate comprises a granular solid. In certain embodiments, the substrate is a road, a stair, a sidewalk, a driveway, a bridge, a ramp, a loading dock, a greenhouse, a hinge, a lock, a control box, a chain, a fire hydrant, rain gutter.

In certain embodiments, the composition includes a substrate, wherein the substrate comprises a granular solid, wherein the granular solid comprises pumice, zeolites, perlite, vermiculite, shale, expanded clay, diatomite, gypsum, sand, limestone, granite, ceramic grains, dielectric grains, dielectric microspheres, ceramic microspheres, gel pak beads, alumina balls, or a combination thereof.

In certain embodiments of the composition, the carbon source is graphite or activated carbon.

In certain embodiments of the composition, the binding agent comprises a sugar polymer, a carbohydrate-based polymer or polydopamine. In some embodiments, the sugar polymer comprises guar gum, agarose or a combination thereof. In some embodiments, the carbohydrate-based polymer comprises corn starch, wheat starch, potato starch, rice starch, tapioca, sago, gum arabic, or a combination thereof.

In certain embodiments of the composition, the binder comprises corn syrup and white vinegar and an optional additional adhesive polymer and a solvent. In some embodiments, the additional adhesive polymer comprises polyvinyl alcohol or polyvinyl pyrrolidone. In some embodiments, the solvent is water, ethanol, methanol, n-butanol, or Tris-HCL Buffer (Tris(hydroxymethyl)aminomethane hydrochloride).

In certain embodiments, the composition is activated when exposed to solar or thermal radiation and is biodegradable.

In certain embodiments, the composition operates by heat transfer of thermal energy from solar radiation or other thermal radiation source to melt surrounding ice, snow, or frost.

In some embodiments, a method of using the composition includes applying the composition to a roadway or highway.

In some embodiments, a method of using the composition includes applying the composition to agricultural equipment.

In some embodiments, a method of using the composition includes applying the composition to agricultural fields and crops.

In some embodiments of the composition, a method of preparation includes the steps of preparing a binder, mixing the binder with a carbon source and a solvent, wherein the composition absorbs solar radiation. The step of preparing the binder may include mixing a binding agent, corn syrup, white vinegar, and optional additional adhesive polymers and a solvent. The additional adhesive agent may comprise polyvinyl alcohol or polyvinyl pyrrolidone. The binder may comprise a sugar polymer, a carbohydrate-based polymer or polydopamine. The sugar polymer may comprise guar gum, agarose or a combination thereof. In some embodiments, the carbohydrate-based polymer comprises corn starch, wheat starch, potato starch, rice starch, tapioca, sago, gum arabic, or a combination thereof. In some embodiments, the solvent is water, ethanol, methanol, n-butanol, or Tris-HCL Buffer (Tris(hydroxymethyl)aminomethane hydrochloride).

In some embodiments, the composition is used as a coating for a substrate. In those embodiments, a method of coating a substrate includes the steps of gathering the substrate in a container, adding the composition to the container, and mixing the substrate and the composition for about 10 minutes to obtain a coated substrate. The method of coating a substrate may further comprise spreading the coated substrate on a tray and drying for about 15 minutes.

The method of coating the substrate may further comprise heating the coated substrate at a temperature of less than about 250° C. in an oven.

The method of coating the substrate may further comprise drying the coated substrate from about 8 hours to about 12 hours.

In certain embodiments, after applying the composition to a surface, at least about 20% mass loss of 0.200kg of ice or snow is achieved after 4 hours of direct sunlight.

In certain embodiments, after applying the composition to a surface, at least about 40% mass loss of 0.200kg of ice or snow is achieved after 6 hours of direct sunlight.

In certain embodiments, after applying the composition to a surface, at least about 50% mass loss of 0.200kg of ice or snow is achieved after 8 hours of direct sunlight.

In certain embodiments, after applying the composition to a surface, at least about 70% mass loss of 0.200kg of ice or snow is achieved after 10 hours of direct sunlight.

In certain embodiments, after applying the composition to a surface, at least about 85% mass loss of 0.200kg of ice or snow is achieved after 12 hours of direct sunlight.

In certain embodiments, after applying the composition to a surface, at least about 30% to about 90% mass loss of 0.200kg of ice or snow is achieved after 12 hours of direct sunlight. These and other features will become readily apparent upon further review of the specification and drawings.

### BRIEF DESCRIPTION OF THE DRAWINGS

Embodiments will be described by way of example only, and not limitation, with reference to the accompanying drawings. The drawings are not necessarily drawn to scale and wherever possible, the same or like reference numbers are used throughout the drawings to refer to the same or like parts.

FIG. 1 is a graph illustrating the percentage of mass lost from blocks of ice covered with different materials over a period of time (hours).

FIG. 2A is a schematic that shows a plastic container holding a grain sample, the grain sample covering a thermocouple probe.

FIG. 2B is a picture showing 4 samples with different sunlight absorbing coatings and two control samples of plain sand and table salt (NaCl).

FIG. 2C is a graph illustrating the change in temperature of the different samples from FIG. 2B as a function of time.

FIG. 2D is a bar chart of the highest slope values for each sample shown in FIG. 2C.

### DETAILED DESCRIPTION

The disclosed composition advances the state of the art, being a biodegradable solar-activated (by visible and infrared radiation) ice and snow melting composition. The biodegradable composition is not toxic to the environment and/or property, is inexpensive and long lasting. The biodegradable composition utilizes a temperature increase through the absorption of solar radiation to transfer heat and melt the surrounding ice and snow from surfaces without the use of any chemical reactions. The biodegradable composition may be combined with a substrate, wherein the resulting composition substrate combination may be applied to property and/or an environmental surface.

As used herein, the term “meltable” refers to a solid which may be converted to a liquid by increasing its liquid surface temperature or ambient room temperature above the melting point for that material. In some embodiments, the solid to be converted to a liquid may be solid forms of water, oil, a water-soluble solution, an alcoholic soluble solution and other aqueous solutions. The alcoholic soluble solutions may be ethanol-based, methanol-based or vinegar based. The term “meltable” also refers to ice, snow or frost.

As used herein, “liquid medium” refers to current compositions that are used to melt ice and/or snow (i.e., a de-icer). The term liquid medium refers to mediums common to the de-icing industry that have the ability to quickly melt snow, ice or frost because of chemical reactions with the snow, ice or frost.

As used herein, “about” refers to any values that are within a variation of ±10%, such that “about 10” would include from 9 to 11. As used herein, “a,” “an,” or “the” refers to one or more, unless otherwise specified. Thus, for example, reference to “an excipient” includes a single excipient as well as a mixture of two or more different excipients, and the like.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

In all embodiments, the biodegradable composition absorbs solar energy. Thus, when a coated medium is placed on a substrate covered with a meltable material, the absorbed solar energy causes the meltable material to melt via heat transfer instead of using a chemical reaction like current de-icers. In all embodiments, when the de-icer absorbs solar energy, melting of the meltable material may occur over several hours and days. In all embodiments, the de-icer may not have to be reapplied to the substrate. In all embodiments, if a rainstorm or snowstorm occurs after application of the de-icer to the substrate, the de-icer may need to be reapplied.

In some embodiments, the biodegradable composition may include a carbon source and a binder, wherein the composition absorbs solar radiation. The binder may include a binding agent. The binding agent may include a sugar polymer, a carbohydrate-based polymer, or polydopamine. In some embodiments, the sugar polymer may be guar gum or agarose. In some embodiments, the carbohydrate-based polymer may include corn starch, wheat starch, potato starch, rice starch, tapioca, sago, gum arabic, or a plant gum. In some embodiments, the carbon source may be activated carbon or graphite. In some embodiments, the binder may include water, cornstarch, corn syrup, white vinegar and a liquid or dry preservative. The liquid preservative may be common mouthwash (Listerine), rosemary extract, forsythia extract, or vitamin E oil. The dry preservative may include sorbic acid or salicylic acid.

In some embodiments, the binding agent may be included in any concentration. The binding agents can vary between 10-40% of the overall composition. The binding strength of the biodegradable composition increases with higher concentrations of binding agent in the composition. The amount of binding agent also affects the viscosity of the composition. The binding agents of the composition are all non-toxic, bio-friendly and water soluble.

In some embodiments, the biodegradable composition is a liquid. In certain embodiments, the biodegradable composition may be sprayed on a substrate, mixed with a substrate or added to a liquid medium as an additive.

In some embodiments, the biodegradable composition may be coated on a surface, on a substrate, or may be mixed with a substrate. The substrate may include a granular solid, such as pumice, zeolite, perlite, vermiculite, shale, expanded clay (i.e., leca balls), diatomite, gypsum, sand, and other soils. The substrate may include limestone, granite, ceramic grains, dielectric grains, dielectric and ceramic microspheres, gel beads, and alumina balls. In some embodiments, the surface may include asphalt, concrete, gravel roads, or farm fields. In some embodiments, the surface may include the exterior surface of vehicles and machinery such as farm equipment, automobiles, tractors, and airplanes. In some embodiments, the surface or substrate may include stairs, sidewalks, bridges, driveways, ramps, loading docks, fire hydrants, rain gutters, roadways, hinges, locks, chains, linkages, water mains, downspouts, or control boxes.

In some embodiments, the biodegradable composition may be mixed with a liquid medium. The liquid medium may be commonly used to melt ice and/or snow in the current market, also known as a de-icer. The liquid medium may include a base solution. The base solution includes glycols, glycerin, alcohols, liquid brines, vinegar, or liquid urea. In certain embodiments, the base solution may include ethylene glycol, diethylene glycol, isopropanol, ethanol, methanol, glycerin, water with a saturated concentration of salt, vinegar or liquid urea. The liquid medium may also include a high concentration of salts, such as magnesium chloride, calcium chloride and sodium chloride, calcium-magnesium acetate, potassium acetate, sodium formate, potassium formate, urea, or a combination thereof.

When the disclosed composition is combined with a liquid medium, it allows for both a fast ice melting response through chemical reaction combined with a slower but long lasting ice-melting response of the heat transferred from the absorption of solar radiation. The composition combined with a common chemical reaction-based de-icer allows for the coating to stay on the surface or substrate for a longer period of time, such as a few weeks, when compared to chemical reaction-based de-icers alone that dissolve within hours. It has been found that the biodegradable composition achieves a long-lasting ice-melting response because it utilizes solar absorption to facilitate heat transfer.

The biodegradable composition includes the following advantages. One advantage is that the composition uses thermal energy from sunlight or other strong visible and infrared electromagnetic radiation. Another advantage is that the composition is non-consumable, i.e., it transfers heat through conduction and convection to the medium or substrate. Because the composition is non-consumable, it is also long acting. Thus, the composition will continue to function as long as the composition has not been dissolved or washed away by an excess of (above freezing temperature) flowing water. In yet another advantage, the composition is non-corrosive making the composition suitable for use in both temporary and permanent applications not compatible with chemical reactive-based de-icers. A new temporary application would be applying this composition to prevent frost and ice build up on transported food and washing the composition away upon successful delivery. A new permanent application would be the incorporation of this composition with curable building materials like concrete, asphalt, brick, or epoxy to increase the thermal energy absorption of common building materials.

In one embodiment, the biodegradable composition may aid with localized melting of ice, snow or frost on small to large areas. The areas may include a road, a highway, a bridge, a roof, a driveway, a lawn, a car and similar vehicles, outdoor equipment such as patio furniture, paints, farming produce, farming structures such as barns, silos, greenhouses, water towers, and any housing structure.

When the composition is added to an area, it can have additional benefits to longer lasting protection from meltable material. For example, if the is added to a roof, it may aid in heating and preserving the heat within the building.

The composition may also be used to reduce the large-scale accumulation of ice or snow. Because the composition is non-toxic and non-corrosive, it may be used over roads, and parkways including nature reserves, farms and on buildings and other fixed structures where non-toxic and non-reactive materials are required. For harsh winter weather protection industries, a non-toxic composition is preferred for safety and ecological friendliness.

In all embodiments, the biodegradable composition may be mixed with a biodegradable glue or binding agent such as a sugar polymer or carbohydrate-based polymer. When mixed with a biodegradable glue or binding agent, the composition may be long lasting when compared to conventional de-icers. The composition including glue may be applied on a surface. When applied to a surface, it may increase the thermal absorption of the surface, reducing the energy requirement to heat a room, or may protect structures and/or fabrics from weather effects. Additionally, by increasing the thermal properties of the surface, it improves the functionality of outdoor cold weather machinery.

In some embodiments, the composition can be added to other building materials like concrete, clay bricks, ceramics, glass, and plastics, epoxy to increase the thermal energy absorption of these common materials when they are exposed to visible or infrared radiation sources. The composition can coat other substrates like granular solids such as granular solid, such as pumice, zeolite, perlite, vermiculite, shale, expanded clay (i.e., leca balls), diatomite, gypsum, soil, sand ceramic grains, dielectric grains, dielectric and ceramic microspheres, gel beads, and alumina balls that can be incorporated with the building material as filler material to add volume to the building material without significantly increasing the weight of the building material. While these coated filler substrates reduce the raw material costs of the building materials, they also increase the thermal energy absorption of the material as the composition is permanently embedded within the composite building material.

In some embodiments, the composition may be easily washed away from surfaces. If the binding agents used in the composition are any form of sugar or carbohydrate-based polymer then the composition may be dissolved by polar-solvents like water or alcohol solvents like isopropanol, ethanol, n-butanol, and methanol. Utilizing a composition with increased thermal absorption properties that can be easily washed away allows for surfaces to be prepared for seasonal changes in the weather.

In yet another advantage, the composition may also serve as a lubricant in addition to increasing the surface thermal absorption of an object. Since the composition contains graphite, a well-known dry lubricant, the composition will reduce the mechanical friction on mechanical machinery, or hinges or other similar fixtures.

In one embodiment, the composition may be mixed with paint. If mixed with paint, the accumulation of snow on top of rooftops may be reduced, which also reduces the need for winter maintenance. The composition may also increase the thermal environment of the internal structure once exposed to sunlight. For example, if the composition is mixed with paint and is used on a greenhouse, then the greenhouse temperature would increase when exposed to sunlight. If the paint is used on pipes or other heating elements, then it will further increase the temperature while protecting the heat conducting elements from the environment. Further, if the coated pipe needs to be exposed to the elements to introduce passive heating, antifreeze mechanisms may be reduced or eliminated.

In another embodiment, the composition may be included with a fabric for use outside. Fabrics such as leather, polyester, olefin, rayon, wool, acetate, cotton, silk, acrylic, linen, velvet, jute, and chenille may be used to cover, for example, wood piles, a lawn mower, a car or a treehouse. When the fabric is used to cover objects outside, the composition aids in protecting the objects from snow and cold by increasing the inner temperature of the covered goods. In yet another embodiment, the composition may be included in previously mentioned fabrics but also apparel fabrics including, chiffon, cotton, crepe, denim, lace, leather, linen, satin, silk, velvet, and wool for use in a blanket or clothing. In such an embodiment, when the fabric is exposed to sunlight, its temperature will rise due to the increase in solar energy absorption from the composition which behaves as a localized heat source to a user, particularly in harsh cold weather. Thus, when the blanket or clothing includes the composition, it may protect the wearer from the environment.

In another embodiment, if the composition is used on the surface of equipment, it may allow equipment to be used in cold weather. The equipment may be a motor vehicle, such as a car, or a bus, a tractor, farming equipment, or an airplane. The equipment may also be machinery that is affected by weather conditions or disabled or malfunction in any way due to meltables remaining in a solid state. Further, having the composition on the equipment may allow use of such equipment in cold climates by increasing the normal temperature. This is achieved by increasing the radiation absorption coefficient of the equipment surface. Therefore, the equipment can be used in weather conditions where they were not used before or increase the usability and/or comfort of the equipment under these conditions. Further, by being able to use the equipment in additional weather conditions, this allows for an increase in total production.

In yet another embodiment, the composition may be used to coat the surface, or part of the surface of an airplane. When used to coat the surface of an airplane, the composition protects the airplane from harmful ice and snow accumulation during flight and during storage when exposed to sunlight or heat lamps. The composition may also allow the airplane to be stored or operated in locations with harmful weather conditions, such as cold temperatures or extreme storm conditions. Applying the composition on the surface of an airplane may also contribute to the safe operation of the airplane in harsh winter conditions. Also, the composition satisfies the requirement for a non-corrosive substance to protect surfaces in aviation.

In another embodiment, the composition may be used in the farming industry. When used in the farming industry, the composition melts ice from a medium or surface. The composition may also aid in increasing sunlight absorption, and/or growing plants in locations under harsh weather conditions. The composition may aid in growing plants inside of a structure, and generally anywhere sunlight or a source of electromagnetic radiation reaches. It has been found that the increase in the absorption coefficient of the surface coated with the composition leads to a greater temperature increase of the surface from the absorption of sunlight, thus aiding in preventing the accumulation of snow or ice on top of grounds or structures in areas where farming equipment is used.

In certain embodiments, the composition may be used on fragile agricultural crops such as grapes, flowers or citrus fruit. The composition may protect the crop from any potential damage from the cold weather in an eco-friendly, biodegradable and non-toxic way. Further, the composition protects the crops from weather changes, even when the weather changes within a short period of time. As the composition can be sprayed on and washed off of crops, it will not affect growing of crops, will have low toxicity, and will not require special chemical handling.

In some embodiments, the composition may be used to reduce heating cost for structures that house livestock. In such embodiment, the composition is dissolved in a dissolving agent, such as ethanol. The dissolved composition is then applied to a roof of the structure housing livestock. This allows for the thermal properties of the surfaces to be adjusted and the thermal energy requirements reduced. Thus, allowing for a cheaper way to grow livestock.

In one embodiment, a method for producing the composition is presented. The method includes preparing a binder by mixing water, a binding agent, corn syrup and white vinegar. The binding agent may include a sugar polymer, a carbohydrate-based polymer or polydopamine. In some embodiments, the sugar polymer may be guar gum or agarose. In some embodiments, the carbohydrate-based polymer may include corn starch, wheat starch, potato starch, rice starch, tapioca, sago, gum arabic, or a plant gum. The mixture is mixed until a uniform mixture is formed. The mixture is then heated until the water has evaporated, which may be from about 1 minute to about 10 minutes, or from about 2 minutes to about 8 minutes, or from about 3 minutes to about 6 minutes. After the water is evaporated, the mixture has a form of a jelly-like substance. The mixture is then cooled. While the mixture is cooled, a second mixture is prepared by mixing water, corn starch and a liquid preservative in a separate container. The second mixture is mixed until uniform, which may be from about 1 minute to about 10 minutes, from about 2 minutes to about 8 minutes, or from about 3 minutes to about 6 minutes. Once uniform, the first mixture is added to the second mixture to form a binder.

After preparing the binder, a carbon source is added to the binder to form a composition. The carbon source may be graphite. The carbon source is added such that the ratio of carbon source to binder is about 1:4. Alternatively, the carbon source to binder ratio may be anywhere from 1:4 to 1:15, where the higher the percentage of carbon in the mixture the stronger the optical absorption capabilities of the end composition will be. Next, an additional adhesive polymer may be added to the carbon source and binder mixture to increase the binding strength of the composition. Additional adhesive polymers that may be used are polyvinyl alcohol or polyvinyl pyrrolidone. Without being limited to a theory, the adhesive polymer improves binding strength of the coating composition. Water is then added to the mixture, which is mixed until uniform, where there are no visible lumps present in the mixture.

In another embodiment, a method of coating a substrate is provided. The method includes adding a substrate into a mixer, such as a mortar mixer or paint mixer, adding the composition of the present disclosure to the mixture and mixing until the composition coats the substrate. The substrate may include a granular solid, such as pumice, zeolite, perlite, vermiculite, shale, expanded clay (i.e., leca balls), diatomite, gypsum, and sand. The substrate may further include limestone, granite, ceramic grains, dielectric grains, dielectric and ceramic microspheres, gel beads, and alumina balls. The substrate may also include sand, soil or concrete. After coating the substrate, the substrate is removed from the mixer and spread on a tray or plate. The substrate is then air dried for about 15 minutes. The tray is then heated at a temperature of less than about 250° C. for about 15 minutes or left exposed to sunlight for at least 2 hours. The coated substrate is then removed and allowed to sit over overnight so that any remaining solvent evaporates.

### EXAMPLES

Specific embodiments of the invention will now be demonstrated by reference to the following examples. It should be understood that these examples are disclosed solely by way of illustrating the invention and should not be taken in any way to limit the scope of the present invention.

### Example 1

### Method 1 of Preparing the Composition

An exemplary embodiment of the composition was prepared by the following method. A base glue (binder) was prepared as follows. A first mixture was prepared by mixing 1.5 cups of water, 0.25 cups of corn syrup, 0.5 cups of cornstarch and 2 teaspoons of white vinegar until it was uniform. The first mixture was heated under medium heat for about 3 minutes until the water evaporated and the mixture formed a jelly-like substance. The first mixture was set aside to cool and a second mixture was prepared.

The second mixture was prepared by mixing 0.5 cups of water, 0.5 cups of cornstarch and 10 mL of a liquid preservative, Listerine, until uniform. A second preservative of 0.50 g of sorbic acid (C₆H₈O₂) was first dissolved in a stirred solution of 35 mL of water and 15 mL of isopropanol. After the sorbic acid has dissolved, it was then added to the second mixture and stirred until the second mixture was uniform. Once the second mixture was uniform, the first mixture was added into the second mixture. The mixture was then mixed until uniform, forming the base glue (binder).

A composition was then prepared using the base glue. Fine powdered graphite was added to the base glue (binder) at a 1:12 weight ratio in a container. Then 115 mL of water was added to the mixture and stirred until no visible lumps were remaining. This completed the composition production.

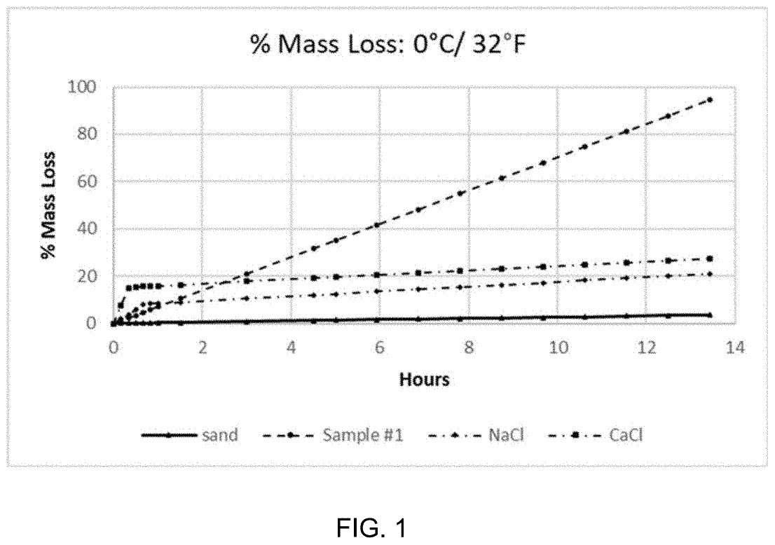

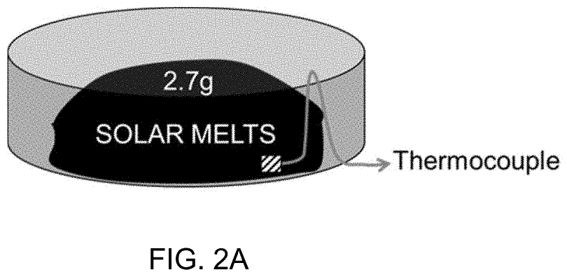

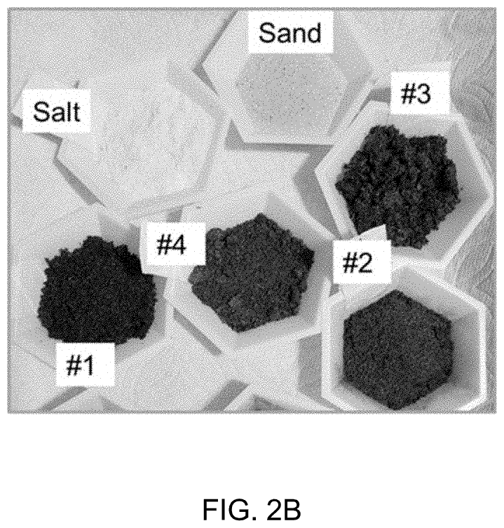

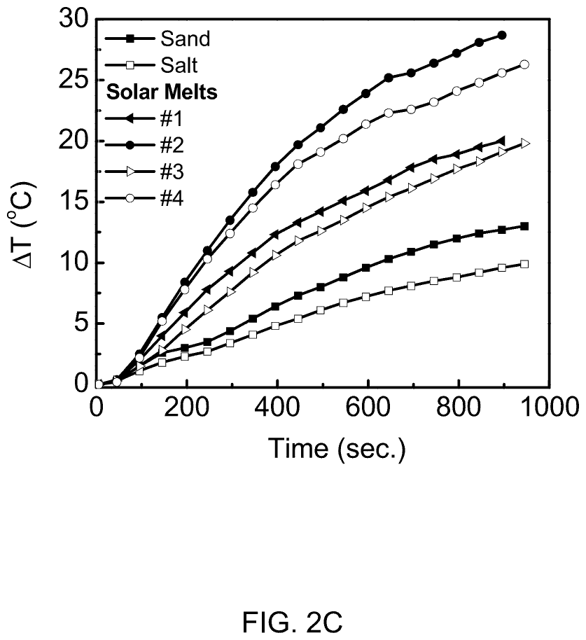

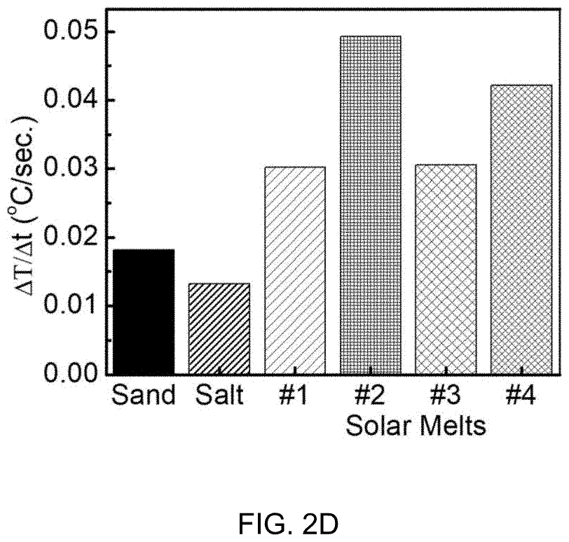

Sand was added to the previously made composition at a ratio of 4.58 parts sand to 1 part composition. Sand and the composition were mixed until the sand was completely covered. The mixture was spread out on a tin tray and left to dry overnight (10 hours). The completely dried mixture of sand covered with the composition is a full test sample used in FIGS. 1 and 2.

### Example 2

### Method 2 of Preparing the Composition

A second exemplary embodiment of the composition was prepared by the following method. 1 g of Dopamine Hydrochloride [β-(3,4-dihydroxyphenyl)-ethylamine hydrochloride 98%)] was dissolved in 10 mL Tris-HCL Buffer (pH=8.5) and left for 15 min to polymerize. The color of the solution changed from transparent to light brown. Another 30 mL of Tris-HCL Buffer was added followed by the addition of 6±0.5 g fine graphite making the mixture black in appearance. To this mixture 150 g sand was added and mixed until all the sand was covered with the black mixture. The sample was heated in an oven at 80° C. until the sample was completely dried.

### Example 3

### Method 3 of Preparing the Composition

A third exemplary embodiment of the composition was prepared by the following method. 15 g Guar Guam was dissolved in 1 cup of warm water followed by the addition of 5 g of fine graphite making the mixture black in appearance. The homogeneous mixture was mixed with 300 g of sand until all the sand was covered with the black mixture. The sample was heated in an oven at 80° C. until the sample was completely dried followed by a mild grinding process to obtain a fine grain size sample.

### Example 4

### Method 4 of Preparing the Composition

A fourth exemplary embodiment of the composition was prepared by the following method. A mixture of 0.25 g Agarose and 25 mL of water was heated in an oven at 50° C. until Agarose completely dissolved in water. Then 5 g or graphite was added followed by the addition of 300 g sand. The sample was heated in an oven at 80° C. until the sample was completely dried followed by a mild grinding process to obtain a fine grain size sample.

### Example 5

### Ice-Melting Rate Comparison

The results of an experiment conducted to compare the ice-melting rate of a substrate coated with an embodiment of the composition of the present disclosure to common salt deicers is shown in FIG. 1. An exemplary sample of sand coated with the composition prepared according to the method described in Example 1. The exemplary sample was compared against sand, a common winter road abrasive, and sodium chloride (NaCl) and calcium chloride (CaCl), two common salt deicers. Each sample was placed on a standard 150mm block of ice under environmental conditions of 0° C./32° F. The ice block and samples were placed in a container with holes in the bottom to allow the ice to drain out as water when heated. The ice block and samples were then exposed to direct sunlight, where the mass loss was measured. As can be seen in FIG. 1, the exemplary sample, ‘Sample #1,’ slowly starts melting the ice on the sand and consistently melts the ice until about 95% of the mass loss is achieved after about 13 hours. Further, the exemplary sample was able to melt the same amount of ice as sand after 0. 5 hours and it equaled the melting ability of NaCl and CaCl after 1.5 and 3 hours, respectively. The NaCl and CaCl samples were found to work quickly to melt the ice but stop melting after about 20% of the ice mass was lost. Therefore, the exemplary sample was able to melt the ice for a longer amount of time when compared to any of the other samples.

### Example 6

### Temperature Increase Rate

Different graphite based coatings were prepared using different binding agents and solvents in combination with graphite. Uncoated samples were also tested as baseline references of a thermal response. The compositions are presented below in Table 1 and the results of the temperature rates for each composition can be found in FIG. 2C and 2D. All tested samples and compositions were placed in a plastic container as shown in FIG. 2A where a small thermocouple was inserted at the bottom of the sample, far from the region of optical illumination. The samples were exposed to direct sun illumination while the temperature of the solid samples (2.7 g each) was monitored. Salt and sand were used as thermal reference samples. Upon the same direct solar illumination, all the samples showed an increase in temperature (FIG. 2C) at different rates. All of the exemplary compositions ended up with a higher heating rate compared to the salt and sand reference samples (FIG. 2D). Heating rates for the samples ‘Sample #1’, ‘Sample #2’, ‘Sample #3’, ‘Sample #4’, salt, and sand were 0.03° C./sec, 0.05° C./sec, 0.03° C./sec, and 0.04° C./sec, 0.013° C./sec, and 0.018° C./sec respectively (FIG. 2D). The heating advantage of the exemplary samples is due to the presence of graphite material.

TABLE 1

| Example | Medium | Binding Agent | Solvent |
|---|---|---|---|
| Sand (Uncoated | Sand | — | — |
| Reference #1) | | | |
| Salt/NaCl | Salt | — | — |
| (Uncoated) | | | |
| Reference #2) | | | |
| Exemplary Sample | Sand | Corn starch | Water |
| #1 | | | |
| Exemplary Sample | Sand | Dopamine | Tris-HCL |
| #2 | | | Buffer |
| Exemplary Sample | Sand | Guar Gum | Water |
| #3 | | | |
| Exemplary Sample | Sand | 2% Agarose | Water |
| #4 | | | |

The change in temperature was analyzed by the following equation:

ΔT=Tᵢ−Tₒ

where Tᵢ corresponds to initial time.

where Tₒ corresponds to the temperature at the measurement time after Tᵢ

The Examples were exposed to direct sunlight for about 20 minutes. The results of the temperature increase can be seen in FIGS. 2c and 2d.

What is claimed is:

1. A composition comprising:
a binder;
a carbon source; and
a solvent;
wherein the binder comprises a binding agent and wherein the composition absorbs solar radiation.

2. The composition of claim 1, further comprising a substrate.

3. The composition of claim 2, wherein the substrate comprises a granular solid.

4. The composition of claim 1, wherein the carbon source is graphite or activated carbon.

5. The composition of claim 1, wherein the binding agent comprises a sugar polymer, a carbohydrate-based polymer or polydopamine.

6. The composition of claim 5, wherein the sugar polymer comprises guar gum, agarose or a combination thereof.

7. The composition of claim 5, wherein the carbohydrate-based polymer comprises corn starch, wheat starch, potato starch, rice starch, tapioca, sago, gum arabic, or a combination thereof.

8. The composition of claim 1, wherein the binder further comprises corn syrup and white vinegar and optional additional adhesive polymers and a solvent.

9. The composition of claim 8, wherein an additional adhesive agent comprises polyvinyl alcohol or polyvinyl pyrrolidone.

10. The composition of claim 8, wherein a solvent is water, ethanol, methanol, n-butanol, or Tris-HCL Buffer (Tris(hydroxymethyl) aminomethane hydrochloride).

11. The composition of claim 1, further comprising a de-icer that is activated when exposed to solar or thermal radiation and is biodegradable.

12. The composition of claim 1, further comprising a de-icer that operates by heat transfer of thermal energy from solar radiation or other thermal radiation source to melt surrounding ice, snow, or frost.

13. A method of using the composition of claim 1, comprising applying the composition to a substrate or a surface.

14. A method of preparing a composition, comprising preparing a binder, and mixing the binder with a carbon source and a solvent, wherein the composition absorbs solar radiation.

15. The method of claim 14, wherein the preparing the binder includes mixing a binding agent, corn syrup, white vinegar, and optional additional adhesive polymers and a solvent.

16. The method of claim 15, wherein an additional adhesive agent comprises polyvinyl alcohol or polyvinyl pyrrolidone.

17. The method of claim 14, wherein the binder comprises a sugar polymer, a carbohydrate-based polymer or polydopamine.

18. The method of claim 17, wherein the sugar polymer comprises guar gum, agarose or a combination thereof.

19. The method of claim 17, wherein the carbohydrate-based polymer comprises corn starch, wheat starch, potato starch, rice starch, tapioca, sago, gum arabic, or a combination thereof.

20. A method of coating a substrate, comprising:
gathering the substrate in a container;
adding a composition to the container;
mixing the substrate and the composition for about 10 minutes to obtain a coated substrate;
spreading the coated substrate on a tray and drying for about 15 minutes; and
heating the coated substrate at a temperature of less than about 250° C. in an oven.
